(19) United States
(12) Patent Application Publication
(10) Pub. No.: US 2023/0285113 A1
(43) Pub. Date: Sep. 14, 2023

(54) WORKING ANGLE GUIDING DEVICE FOR DENTAL IMPLANT AND METHOD THEREOF

(71) Applicants: PAI-YU KO, Taichung City (TW); BAI-CIAN KE, Taichung City (TW); HSIANG-YI LIN, Taichung City (TW)

(72) Inventors: PAI-YU KO, Taichung City (TW); BAI-CIAN KE, Taichung City (TW); HSIANG-YI LIN, Taichung City (TW); FU-HSIANG YANG, Taichung City (TW)

(21) Appl. No.: 17/883,569

(22) Filed: Aug. 8, 2022

(30) Foreign Application Priority Data
Mar. 11, 2022 (TW) 111109090

(51) Int. Cl. A61C 1/00; A61C 1/08

(52) U.S. Cl. CPC A61C 1/0015; A61C 1/084

(57) ABSTRACT

The present invention provides a working angle guiding device for dental implant and a method thereof. The working angle guiding device includes an intraoral securing device, a hand-held tool, a first triaxial attitude information sensor, a second triaxial attitude information sensor, and a controller. The working angle guiding method includes a preparing step, an installing step, a correcting step, a moving step, and a working angle adjusting step. The relative angle information of the first triaxial attitude information sensor and the second triaxial attitude information sensor is utilized to assist and guide the dentist to acquire the angle of implant drilling. The present invention has advantages in that the triaxial angle of the drill hole can be confirmed even after the patient dodges, tilts or moves his/her head, and that the first triaxial attitude information sensor can be flexibly mounted in the mouth or outside the mouth.

### BACKGROUND OF THE PRESENT INVENTION

### Field of Invention

The present invention relates to a working angle guiding device for dental implant and a method thereof. Particularly, it relates to a working angle guiding device and method for dental implant that allows the triaxial angle of the drill hole be confirmed even after the patient tilts, dodges or moves his/her head, and allows a first triaxial attitude information sensor thereof be elastically mounted in the mouth or outside the mouth.

### Description of Related Arts

FIG. 1 is a perspective view illustrating a general patient lying on a dental chair, while a dentist holds a hand-held device 91 to treat the patient's teeth or gums. For example, when drilling for dental implant, dentists usually first analyze and determine where to start drilling, in what angle of drilling, and how deep to drill, in order to achieve the best results.

However, patients sometimes dodge or move their heads slightly because of fear or discomfort, making it difficult for dentists to grasp the precise drilling angle while drilling a hole. Especially if the patient dodges or moves while drilling, it is even more difficult to confirm the drilling angle of the drilling.

Taiwan Patent Publication No. TW202019351A which is published on Jun. 1, 2020, is disclosed with the title of “Clinical Dental Education and Training System and Method Thereof”. It has an image tracking capture system (not shown), which can capture a positioning plate (not shown) affixed on the patient's face. In other words, this prior technology mainly uses optical images to obtain several positioning marks (not shown) on the positioning plate, thereby achieving the purpose of positioning. However, although such method that applies optical tracking can obtain the spatial position information of the patient's face, due to the lack of light in the mouth, the image inside the oral cavity is difficult to be clear. In addition, the filming angle is often blocked by teeth or lips, etc., rendering positioning failures. Therefore, such prior art is not suitable as an auxiliary tool for implant drilling.

PCT International Patent Publication No. WO2020/249843A1 which is published on Dec. 17, 2020, is disclosed with the title of “Accessory System for a Manual Machining Tool”. According to this prior technology, a connecting device 92 is provided on a hand-held device 91, as illustrated in FIG. 1. The connecting device 92 has a screen 93 that can display the relative spatial position of the hand-held device 91 relative to a reference point. The hand-held device 91 uses an accelerometer or a gyroscope to obtain the acceleration change and the angular velocity change of the three axes (i.e., the X, Y, and Z axes). Unfortunately, in this case, only the spatial information of the hand-held device 91 can be obtained. Once the patient dodges, tilts or moves his/her head, resulting in the change of the absolute position or angle, the drilling point and angle information will become inaccurate. Therefore, this prior technology is still not suitable for the drilling procedure of dental implant.

In addition, since the hole for the dental implant is drilled into the bone in the patient's gum, it is almost impossible to redo the drilling after a failed one. Once the drilling angle is wrong, the denture unit that needs to be implanted will be tilted incorrectly, rendering, in a less serious case, an unsightly result (slightly skewed), in a more serious case, interferences to the adjacent teeth or poor occlusion, and, in the worst case, medical disputes or lawsuits.

In view of this, it is necessary to develop a technology that solves the above-mentioned drawbacks of the prior technologies.

### SUMMARY OF THE PRESENT INVENTION

An object of the present invention is to provide a working angle guiding device for dental implant and a method thereof, which have the advantages in confirming the triaxial angle of the drill hole even after the patient tilts, dodges or moves his/her head and in flexibly allowing the first triaxial attitude information sensor to be mounted intraorally or extraorally. In particular, a problem to be solved by the present invention is that in traditional dental implant process, when the patient tilts, dodges or moves head, the information for the drilling point and drilling angle becomes inaccurate.

In order to solve the above-mentioned problem, a technical solution is provided. It is a working angle guiding device and a method thereof for dental implant. The working angle guiding device for dental implant comprises:
an intraoral securing device, adapted for being installed in an oral cavity, wherein the intraoral securing device has a fixing portion, a gum covering portion and a first supporting portion, wherein the fixing portion is fixed in the oral cavity having at least one gum, wherein the gum covering portion is adapted to cover on the gum and has at least one marking portion, wherein the first supporting portion, the gum covering portion, and the fixing portion are integrally formed;
a hand-held tool, arranged corresponding to the intraoral securing device and having a working portion and a second supporting portion;
a first triaxial attitude information sensor, arranged on the first supporting portion, so as for detecting a first triaxial attitude information;
a second triaxial attitude information sensor, arranged on the second supporting portion, so as for detecting a second triaxial attitude information; and
a controller, electrically connected with the first triaxial attitude information sensor and the second triaxial attitude information sensor, wherein the controller comprises a processing unit, a display unit, and a control interface, wherein the processing unit respectively obtains the first triaxial attitude information and the second triaxial attitude information through the first triaxial attitude information sensor and the second triaxial attitude information sensor, and respectively displays the first triaxial attitude information and the second triaxial attitude information through the display unit.

The working angle guiding method for dental implant includes the following steps:
(1) preparing step;
(2) installing step;
(3) correcting step;
(4) moving step; and
(5) working angle adjusting step.

The above objects and advantages of the present invention can be easily understood from the detailed description and appended drawings of the following embodiments.

Hereinafter, the present invention will be described in detail with the following embodiments with the drawings.

### BRIEF DESCRIPTION OF THE DRAWINGS

FIG. 1 is a perspective view illustrating treating an oral cavity with a traditional hand-held device.

FIG. 2 is a perspective view of a device according to the present invention.

FIG. 3 is a partially enlarged perspective view of the present invention.

FIG. 4 is a sectional view taken along line IV-IV of FIG. 3.

FIG. 5 is a sectional view taken along line V-V of FIG. 3.

FIG. 6 is a perspective view of the drilling angle of a dental implant according to the present invention.

FIG. 7 is a flow diagram of a method according to the present invention.

FIG. 8 is a perspective view of an alignment operation of the correcting step according to the present invention.

FIG. 9 is a perspective view of the first supporting portion according to the present invention being set at a position facing the outside of the mouth.

FIG. 10 is a perspective view of another embodiment of the fixing portion according to the present invention.

### DETAILED DESCRIPTION OF THE PREFERRED EMBODIMENT

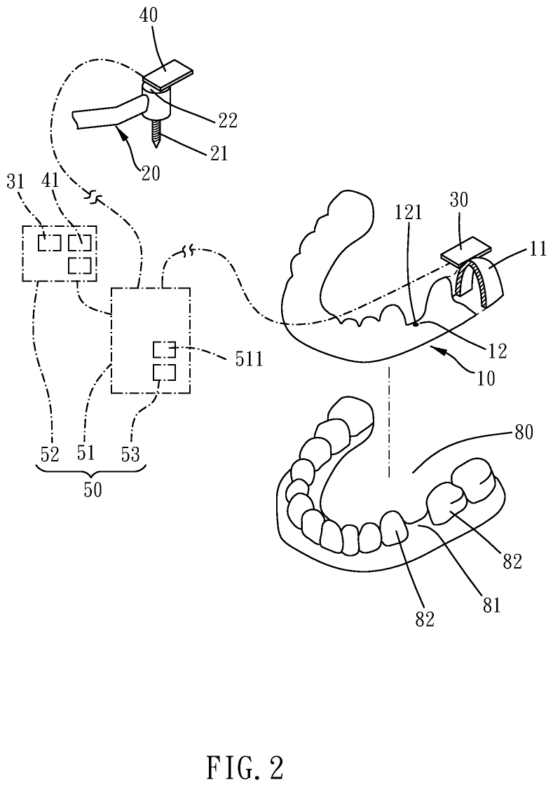

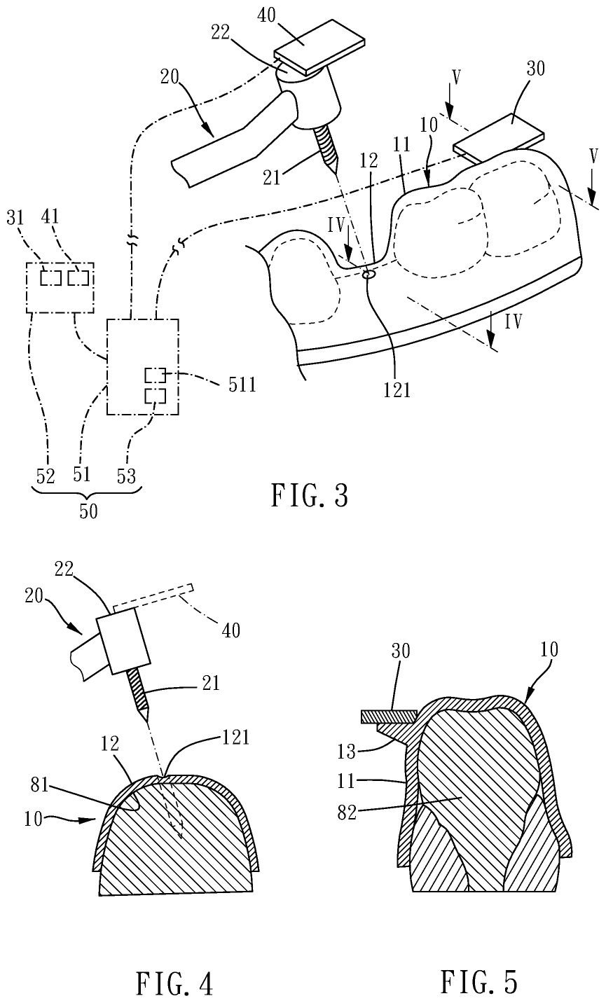

The present invention relates to a working angle guiding device for dental implant (or called dental implantation) and a method thereof. Referring to FIGS. 2, 3, 4, and 5, the working angle guiding device for dental implant includes an intraoral securing device 10, a hand-held tool 20, a first triaxial attitude information sensor 30, a second triaxial attitude information sensor 40, and a controller 50.

The intraoral securing device 10 is adapted to be mounted in an oral cavity 80. The intraoral securing device 10 has a fixing portion 11, a gum covering portion 12, and a first supporting portion 13. The fixing portion 11 is adapted to be affixed in the oral cavity 80. The oral cavity 80 has at least one gum 81 therein. The gum covering portion 12 is utilized to cover the gum 81. The gum covering portion 12 has at least one marking portion 121 arranged thereon. The first supporting portion 13, the gum covering portion 12, and the fixing portion 11 are integrally formed.

The hand-held tool 20 is provided to correspond to the intraoral securing device 10. The hand-held tool 20 has a working portion 21 and a second supporting portion 22.

The first triaxial attitude information sensor 30 is disposed on the first supporting portion 13 for detecting a first triaxial attitude information 31.

The second triaxial attitude information sensor 40 is disposed on the second supporting portion 22 for detecting a second triaxial attitude information 41.

The controller 50 is electrically connected with the first triaxial attitude information sensor 30 and the second triaxial attitude information sensor 40. The controller 50 comprises a processing unit 51, a display unit 52, and a control interface 53 (for example, a button, a touch input unit, a voice control input unit, etc.). The processing unit 51 acquires (or receives) the first triaxial attitude information 31 and the second triaxial attitude information 41 respectively through the first triaxial attitude information sensor 30 and the second triaxial attitude information sensor 40, and displays the first triaxial attitude information 31 and the second triaxial attitude information 41 respectively through the display unit 52.

In practice, the intraoral securing device 10 can be either a transparent or non-transparent structure (brace).

Patients waiting for dental implant may be completely edentulous or only have a few of the teeth missing.

When facing the toothless person, the fixing portion 11 must be affixed in the oral cavity 80 through bone nail (a known technology, not shown in the figure) or adhesive.

When there is still at least one tooth 82 in the oral cavity 80, the fixing portion 11 is adapted to be affixed on the at least one tooth 82, as illustrated in FIG. 2, in the oral cavity 80.

The at least one marking portion 121 can be selected from the group consisting of at least one mark, recess, hole, and combinations thereof.

The quantity of the marking portion 121 can be more than one, according to the quantity of the teeth to be implanted.

The first triaxial attitude information 31 and the second triaxial attitude information 41 mentioned above are both the angular velocity of an object in a three-dimensional space, that is, the angular velocity of the X-axis, the angular velocity of the Y-axis, and the angular velocity of the Z-axis. Practically, it can be performed and achieved through utilizing a gyroscope or a three-axis accelerometer. The acceleration change in the three-dimensional space can be utilized to find out whether the posture has changed, which achieves the same effect and function. Alternatively, an existing commercially available or customized inertial measurement unit (IMU) can be utilized to measure the three-axis attitude angle (or angular rate) and six real-time information of the acceleration of the object, which are the angular velocity of X-axis, Y-axis and Z-axis, and the acceleration of X-axis, Y-axis and Z-axis.

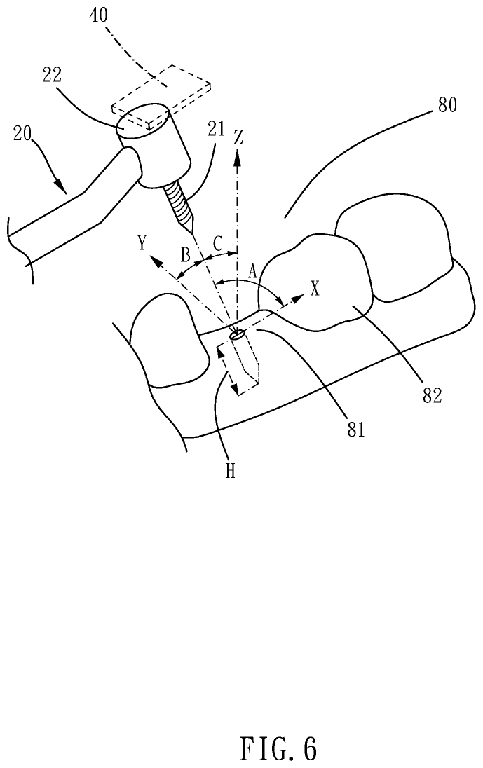

FIG. 6 is a perspective view of the drilling angle of the dental implant according to the present invention, in which the intraoral securing device 10 is not shown, so as to illustrate the positions of the X-axis, the Y-axis, the Z-axis, the working angle of the dental implant, and a working depth H, wherein a first angle A, a second angle B, and a third angle C represent the angle between the working portion 21 and the X-axis, the angle between the working portion 21 and the Y-axis, and the angle between the working portion 21 and the Z-axis, respectively.

More specifically, the processing unit 50 may further include a correction processing module 511, which corrects the first triaxial attitude information 31 and the second triaxial attitude information 41 to a same value. In practice, the two values can be synchronized or both can be reset to zero. For example: the angular velocities of the X-axis, Y-axis, and Z-axis of the first triaxial attitude information 31 are 1.7, 5.5, −3.9, respectively, and the angular velocities of the X-axis, the Y-axis, and the Z-axis of the second triaxial attitude information 41 are 9.2, −1.2, and −8.1, respectively. The angular velocities of the X-axis, Y-axis, and Z-axis of the second triaxial attitude information 41 can also be changed to 1.7, 5.5, −3.9, or the two sets of data can both be reset to 0.0, 0.0, 0.0.

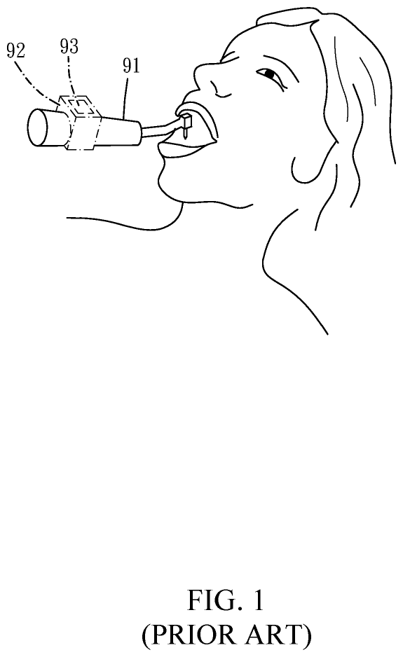

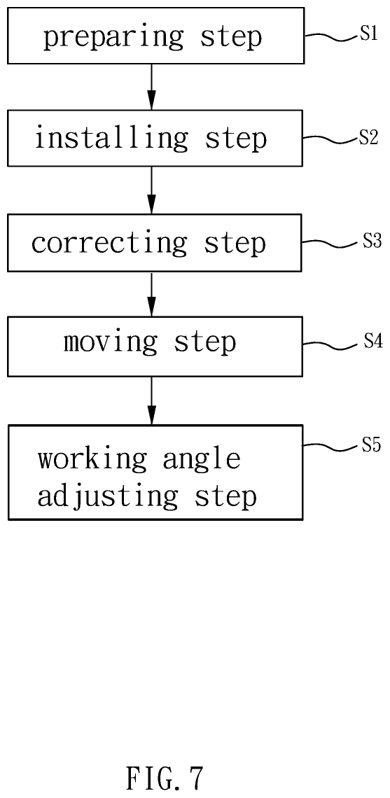

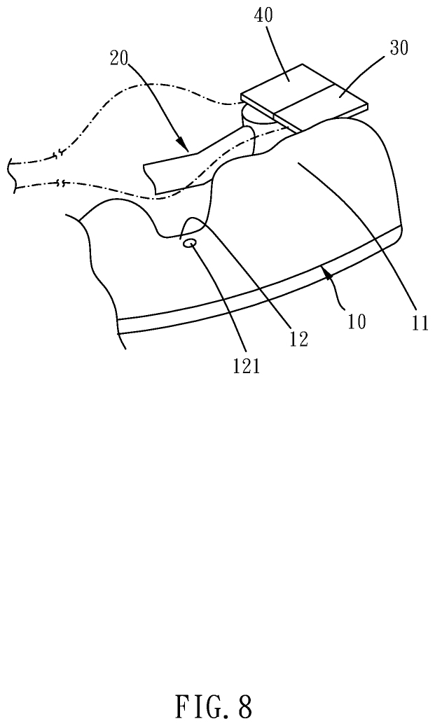

Referring to FIG. 7 (one may also be utilized in conjunction with the FIGS. 1-6), the working angle guiding method for dental implant includes the following steps:
(1) preparing step S1: preparing a working angle guiding device for dental implant, which comprises:
an intraoral securing device 10 having a fixing portion 11, a gum covering portion 12, and a first supporting portion 13, wherein the gum covering portion 12 has at least one marking portion 121, wherein the first supporting portion 13, the gum covering portion 12, and the fixing portion 11 are integrally formed;
a hand-held tool 20, provided to correspond to the intraoral securing device 10, wherein the hand-held tool 20 has a working portion 21 and a second supporting portion 22;
a first triaxial attitude information sensor 30, arranged on the first supporting portion 13, so as for detecting a first triaxial attitude information 31;
a second triaxial attitude information sensor 40, arranged on the second supporting portion 22, so as for detecting a second triaxial attitude information 41; and
a controller 50, electrically connected with the first triaxial attitude information sensor 30 and the second triaxial attitude information sensor 40, wherein the controller 50 comprises a processing unit 51, a display unit 52, and a control interface 53 (for example, a button, a touch input unit, a voice control input unit, etc.), wherein the processing unit 51 has a correction processing module 511, wherein the processing unit 51 acquires the first triaxial attitude information 31 and the second triaxial attitude information 41 respectively through the first triaxial attitude information sensor 30 and the second triaxial attitude information sensor 40, and displays the first triaxial attitude information 31 and the second triaxial attitude information 41 respectively through the display unit 52;
(2) installing step S2: affixing the fixing portion 11 in an oral cavity 80, wherein the oral cavity 80 has at least one gum 81, wherein the gum covering portion 12 is utilized to cover the gum 81;
(3) correcting step S3: contacting and aligning the first triaxial attitude information sensor 30 and the second triaxial attitude information sensor 40, so as to unify the triaxial attitudes thereof, as illustrated in FIG. 8, and then, activating the correction processing module 511, which corrects the first triaxial attitude information 31 and the second triaxial attitude information 41 to the same value;
(4) moving step S4: moving the hand-held tool 20 to have the working portion 21 contact the marking portion 121 arranged on the gum covering portion 12; and
(5) working angle adjusting step S5: adjusting the triaxial attitude of the working portion 21 of the hand-held tool 20 according to the first triaxial attitude information 31 and the second triaxial attitude information 41 displayed on the display unit 52, which enables a guiding function of the working angle of dental implant.

Afterwards, the dentist can refer to the first triaxial attitude information 31 and the second triaxial attitude information 41 displayed on the display unit 52 to first confirm whether the triaxial angle to be drilled is correct, and then perform the drilling operation.

In particular, in the working angle adjusting step S5, if the patient sometimes dodges, tilts or moves his/her head slightly due to fear or discomfort, the relative angle relationship between the hand-held tool 20 and the marking portion 121 can still be controlled.

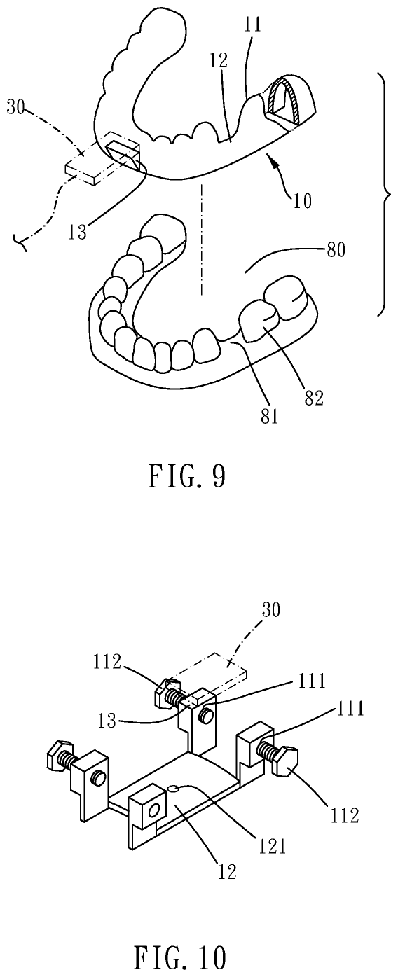

In addition, the position of the first supporting portion 13 may be arranged in the oral cavity 80, or may be extended to the outside of the oral cavity 80. For example, as illustrated in FIG. 9, the first supporting portion 13 is extended from the vicinity of the incisors toward the outside of the mouth. Furthermore, if the first triaxial attitude information sensor 30 is too large to be mounted in the mouth, it can also be mounted outside the oral cavity 80.

Furthermore, referring to FIG. 10, the fixing portion 11 may also be modified to have a corresponding structure of a plurality of locking portions 111 (e.g., screw holes) and a plurality of locking members 112.

The plurality of locking portions 111 are integrally connected with the first supporting portion 13.

The plurality of locking portions 111 and the plurality of locking members 112 are respectively utilized to be affixed on the corresponding tooth 82.

Advantages and effects provided by the present invention may generally include the following:

First, the triaxial angle of the drill hole can still be confirmed after the patient's head is tilted, dodged, or moved. Since the first triaxial attitude information sensor and the second triaxial attitude information sensor according to the present invention are in contact with each other and aligned, so as to allow the two have the same triaxial attitude (that is, the correcting step), then, even if the patient tilts, dodges or moves head, thereby changing the triaxial attitude in the three-dimensional space, the relative angular relationship between the hand-held tool and the marking portion can still be grasped and controlled, which is of great help for the dentist to perform the drilling procedure for the dental implant. Therefore, the triaxial angle of the drill hole can still be confirmed and identified after the patient's head is tilted, dodged, or moved.

Second, the first triaxial attitude information sensor can be mounted in the mouth or outside the mouth, which is more flexible in use. Since the first triaxial attitude information sensor is mounted on the first supporting portion, it allows the first supporting portion to be arranged in the mouth or outside the mouth, which is flexible. Therefore, the first triaxial attitude information sensor can be mounted in the mouth or outside the mouth, which is more flexible in use.

The above is only to describe the present invention in detail by means of preferred embodiments, and any simple modifications and changes made to the embodiments without departing from the spirit of the present invention are within the scope of the present invention.

What is claimed is:

1. A working angle guiding device for dental implant, comprising:
an intraoral securing device, adapted for being installed in an oral cavity, said intraoral securing device having a fixing portion, a gum covering portion and a first supporting portion, said fixing portion being fixed in the oral cavity having at least one gum, said gum covering portion being adapted to cover on the gum and has at least one marking portion, and wherein said first supporting portion, said gum covering portion, and said fixing portion are integrally formed;
a hand-held tool, arranged corresponding to said intraoral securing device and having a working portion and a second supporting portion;
a first triaxial attitude information sensor, arranged on said first supporting portion, so as for detecting a first triaxial attitude information;
a second triaxial attitude information sensor, arranged on said second supporting portion, so as for detecting a second triaxial attitude information; and
a controller, electrically connected with said first triaxial attitude information sensor and said second triaxial attitude information sensor, wherein said controller comprises a processing unit, a display unit, and a control interface, wherein said processing unit respectively obtains said first triaxial attitude information and said second triaxial attitude information through said first triaxial attitude information sensor and said second triaxial attitude information sensor, and respectively displays said first triaxial attitude information and said second triaxial attitude information through said display unit.

2. The working angle guiding device for dental implant as defined in claim 1,
wherein the oral cavity has at least one tooth, wherein said fixing portion is adapted to be affixed on the at least one tooth.

3. The working angle guiding device for dental implant as defined in claim 1,
wherein said at least one marking portion is selected from the group consisting of a mark, a recess, a hole, and combinations thereof.

4. The working angle guiding device for dental implant as defined in claim 1,
wherein said processing unit further comprises a correction processing module, which corrects said first triaxial attitude information and said second triaxial attitude information into a same value.

5. A working angle guiding method for dental implant, comprising the following steps:
(1) preparing step: preparing a working angle guiding device for dental implant, which comprises:
an intraoral securing device, which has a fixing portion, a gum covering portion, and a first supporting portion, wherein the gum covering portion has at least one marking portion, wherein the first supporting portion, the gum covering portion, and the fixing portion are an integral structure;
a hand-held tool, arranged corresponding to the intraoral securing device, and having a working portion and a second supporting portion;
a first triaxial attitude information sensor, arranged on the first supporting portion, so as for detecting a first triaxial attitude information;
a second triaxial attitude information sensor, arranged on the second supporting portion, so as for detecting a second triaxial attitude information; and
a controller, electrically connected with the first triaxial attitude information sensor and the second triaxial attitude information sensor, wherein the controller comprises a processing unit, a display unit, and a control interface, wherein the processing unit has a correction processing module, wherein the processing unit respectively obtains the first triaxial attitude information and the second triaxial attitude information through the first triaxial attitude information sensor and the second triaxial attitude information sensor, and respectively displays the first triaxial attitude information and the second triaxial attitude information through the display unit;
(2) installing step: affixing the fixing portion in an oral cavity, wherein the oral cavity has at least one gum, wherein the gum covering portion is utilized to cover the gum;
(3) correcting step: contacting and aligning the first triaxial attitude information sensor with the second triaxial attitude information sensor, so as to unify the triaxial attitudes thereof, then activating the correction processing module, which corrects the first triaxial attitude information and the second triaxial attitude information to the same value;
(4) moving step: moving the hand-held tool to have the working portion contact the marking portion arranged on the gum covering portion; and
(5) working angle adjusting step: adjusting the triaxial attitude of the working portion of the hand-held tool according to the first triaxial attitude information and the second triaxial attitude information displayed on the display unit, which enables a guiding function of the working angle of dental implant.

6. The working angle guiding method for dental implant as defined in claim 5,
wherein the at least one marking portion is selected from the group consisting of a mark, a recess, a hole, and combinations thereof.
